(19) United States
(12) Patent Application Publication
(10) Pub. No.: US 2008/0145585 A1
(43) Pub. Date: Jun. 19, 2008

(54) FLOCKED SLURRIED THERMOSETTING ADHESIVE ARTICLE

(75) Inventor: Louis Brown Abrams, Fort Collins, CO (US)

Correspondence Address: SHERIDAN ROSS PC, 1560 BROADWAY, SUITE 1200, DENVER, CO, 80202, US

(73) Assignee: HIGH VOLTAGE GRAPHICS, INC., Fort Collins, CO (US)

(21) Appl. No.: 11/957,205

(22) Filed: Dec. 14, 2007

Related U.S. Application Data
(60) Provisional application No. 60/870,281, filed on Dec. 15, 2006.

(51) Int. Cl. B32B 33/00; B32B 37/12; B05D 1/16

(52) U.S. Cl. 428/40.1; 156/60; 428/90

(57) ABSTRACT

A design and process are provided in which a thermosetting adhesive layer is applied as a slurry to a flocked surface.

### CROSS REFERENCE TO RELATED APPLICATIONS

The present application claims benefit of U.S. Provisional Patent Application Serial Number No. 60/870,281, filed Dec. 15, 2006, to Abrams, which is incorporated herein by reference.

### FIELD OF THE INVENTION

The invention relates generally to flocked articles and particularly to flocked adhesive articles.

### BACKGROUND OF THE INVENTION

Flocked articles are used in a wide variety of applications. For example, flocked articles are used as patches, transfers, molded objects, and the like. Flock is much less expensive than woven articles while providing a plusher feel.

In a typical manufacturing process, the flock is first adhered to a release adhesive printed onto a carrier sheet. A liquid permanent adhesive is then applied to the exposed ends of the flock fibers. The liquid adhesive can be precisely applied in a desired pattern on the flock. When the applied adhesive is adhered to a substrate, only the flock fibers desired in the final pattern will remain on the substrate after the carrier sheet is removed. To maintain the plush feel, it is important not only to provide for the proper orientation of the flock relative to the adhesive layer but also to prevent the liquid adhesive from flowing into and between the flock fibers. Additionally, liquid adhesives typically have volatile solvents, which can be not only environmentally damaging but also present substantial hazards to manufacturing personnel.

In another typical manufacturing process, a permanent adhesive is dissolved in a solvent to form an adhesive solution. An adhesive solution means a homogeneous mixture of the permanent adhesive in the solvent, that is, the permanent adhesive is solubilized in the solvent and the adhesive solution is substantially free of any solid adhesive particles. The solvent is typically an organic liquid. Organic liquids are typically less preferred due to their hazardous health, safety, and/or environmental properties. After precisely applying the adhesive solution in a desired pattern on the flock, the solvent is at least mostly evaporated, leaving a permanent adhesive layer substantially free of solvent on the flock. When the remaining adhesive layer is adhered to a substrate, only the flock fibers resembling the desired pattern will remain on the substrate after the carrier sheet is removed.

In yet another typical manufacturing process, after precisely applying the adhesive solution in the desired pattern to the flock, but before the solvent is evaporated, a plurality of dry, powdered thermoplastic adhesive particles are contacted with the adhesive solution.

One technique for overcoming these problems is to adhere a pre-formed, self-supporting thermosetting adhesive film to the flock. The use of the self-supporting film inhibits flow of the adhesive too far up the fibers and, being pre-formed, does not require volatile, harmful solvents for adhesive application. The adhesive, when fully activated or cross-linked, can permanently adhere the flock to a desired substrate.

A problem, however, exists in manufacturing transfers. To more effectively adhere desired flocked patterns selectively to substrates, the adhesive film must be pre-cut before application to the flock. In this way, when the carrier sheet is removed, after application of the transfer to the substrate, only the flock engaging the pre-cut adhesive film will remain on the substrate. The flock not engaging the pre-cut adhesive film will be removed with the carrier sheet. Pre-cutting of the adhesive film can increase manufacturing costs as it represents an additional step in the manufacturing process.

### SUMMARY OF THE INVENTION

These and other needs are addressed by the various embodiments and configurations of the present invention.

In one embodiment, a method for manufacturing a flocked article is provided that includes the steps:

forming an adhesive slurry comprising a carrier liquid and particles of a thermosetting adhesive, wherein the particles are capable of being cured, that is, the particles are not substantially C-staged; and

printing the adhesive slurry onto a flocked surface in a desired pattern.

The slurry is preferably a water-based suspension of finely sized thermosetting adhesive particles. The particles are preferably a polyurethane adhesive with a polyisocyanate curing agent. The slurry is preferably screen printed onto the tips or ends of the flock fibers in a desired pattern that is the same as the final (applied) flock pattern. The slurry is allowed to dry, leaving the adhesive particles attached to the ends of the flock. The adhesive-coated flock can then be contacted under pressure with a desired substrate surface and heated. During heating, the thermosetting adhesive particles can become thermoplastic (that is, be A- and/or B-staged) and can eventually be substantially fully cured (that is, B- and/or C-staged). A-stage of a thermosetting adhesive means the early stage of the cross-linking reactions of the adhesive, wherein the adhesive is liquefied by heat and soluble in certain liquids. B-stage of a thermosetting adhesive means an intermediate stage in the reaction of a thermosetting adhesive where the adhesive may not entirely fuse or dissolve, that is, the adhesive softens when heated and swells when in contact with certain liquids. C-stage of a thermosetting adhesive means the final stage of the cross-linking reaction of a thermosetting adhesive, the adhesive is substantially insoluble and infusible, that is, the adhesive is substantially incapable of being softened or liquefied by heat. The carrier sheet and release adhesive are then removed. In the preferred configuration, only the flock fibers to which the adhesive slurry was applied will be adhered to the substrate. The unprinted flock fibers, that is, the flock fibers that did not have the adhesive slurry applied in the printing process, will not adhere to the substrate. When the carrier sheet is removed, the unprinted flock fibers are removed with the carrier sheet and release adhesive.

In another embodiment, a method of manufacturing a flocked article is provided that includes the steps:

printing a thermoset and/or thermoplastic liquid adhesive onto a flocked surface in a desired pattern,

contacting the printed liquid adhesive with a plurality of thermosetting adhesive particles, wherein at least most of the plurality of thermosetting particles are not substantially B- and/or C-staged.

In this manner, finely detailed flocked images can be produced on a desired substrate without the need for the die cutting and weeding operations used in the prior art. Additionally, the amount of wasted material from such operations can be reduced substantially. Thermosetting adhesive particles are preferred for one or more of: a) their temperature resistance (after C-staging will not melt or deform when heated); b) their greater degree of chemical resistance (for example, a solvent will not dissolve or softened a C-staged thermoset adhesive); and c) their cross-linkage with the printed liquid adhesive. Supplementing a thin printed liquid adhesive layer with thermosetting adhesive particles allows for an equal or greater amount of adhesive to be applied with less solvent. Some of the advantages of applying a thinner printed liquid adhesive layer are: less volatile organics are released when the solvents are evaporated; the evaporation time can be reduced; and the energy requirements to evaporate the solvent can be reduced. The printed liquid adhesive layer is relatively thin, preferably having a thickness of no more than about 5 mils, to inhibit flock fibers being repositioned from the original orthogonal orientation (relative to the carrier sheet and printed adhesive layer) to an undesirable non-orthogonal orientation. This undesirable non-orthogonal orientation can occur during heating and applying of pressure to the carrier sheet.

In yet another embodiment, a method of manufacturing a flocked article is provided that includes the steps:

printing a carrier liquid onto a flocked surface in a desired pattern, wherein the carrier liquid is free of adhesive particles and wherein the carrier liquid is neither a thermosetting or thermoplastic adhesive;

contacting the carrier liquid with a plurality of thermosetting adhesive particles, wherein at least most of the plurality of thermosetting particles are not substantially C-staged.

In this manner, finely detailed flocked images can be produced on a desired substrate without the need for the die cutting and weeding operations used in the prior art. Additionally, the amount of wasted material from such operations can be reduced substantially.

The printed adhesive layer is relatively thin, preferably having a thickness of no more than about 5 mils, to inhibit flock fibers being repositioned from the original orthogonal orientation (relative to the carrier sheet and printed adhesive layer) to an undesirable non-orthogonal orientation. This undesirable non-orthogonal orientation can occur during heating and applying of pressure to the carrier sheet.

The present invention can provide the benefits of liquid adhesives, namely printing of precise and finely detailed patterns, without the health and environmental hazard drawbacks from toxic and volatile adhesive solvents.

Thermosetting adhesives, when in the thermoset state, are highly resistant to wear and tear and high temperatures. Such adhesives permit flocked designs to be used in more demanding applications, such as automotive applications, food and drink dispenser applications, and textile applications.

These and other advantages will be apparent from the disclosure of the invention(s) contained herein.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

It is to be noted that the term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably. The above-described embodiments and configurations are neither complete nor exhaustive. As will be appreciated, other embodiments of the invention are possible utilizing, alone or in combination, one or more of the features set forth above or described in detail below.

### BRIEF DESCRIPTION OF THE DRAWINGS

FIG. 1 is a side view of a flocked carrier sheet according to an embodiment of the present invention;

FIG. 2 is a side view of a flocked intermediate assembly according to an embodiment of the present invention;

FIG. 3 is a side view of a flocked transfer according to an embodiment of the present invention;

FIG. 4 is a plane view of the transfer of FIG. 3;

FIG. 5 is a flow chart of a manufacturing line according to an embodiment of the present invention;

FIG. 6 is a flow chart of a manufacturing line according to another embodiment of the present invention; and

FIG. 7 is a side view of a flocked transfer according to another embodiment of the present invention.

### DETAILED DESCRIPTION

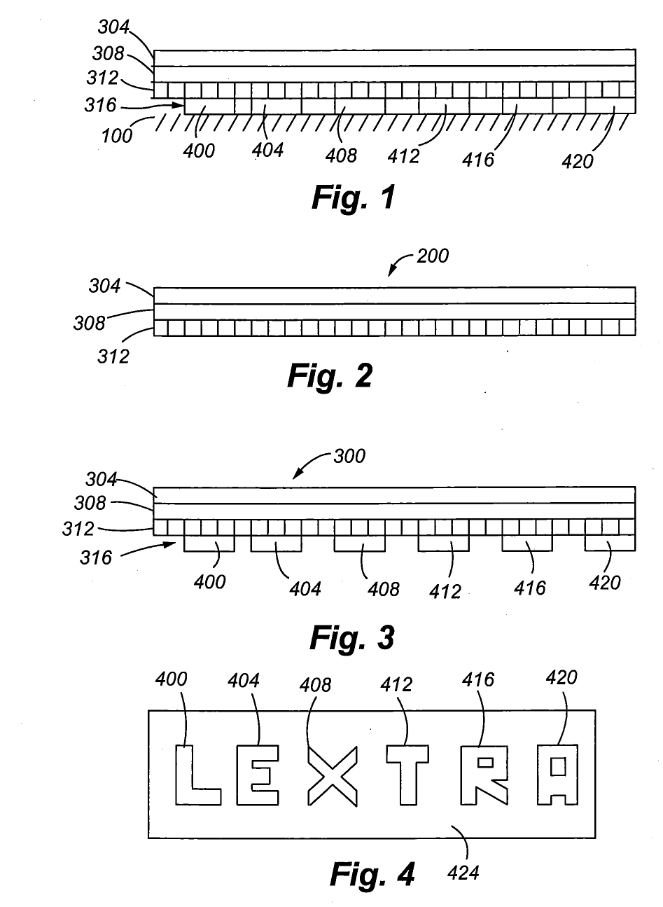

FIG. 3 shows a flocked transfer 300 according to an embodiment of the present invention. The transfer 300 includes a carrier sheet 304, release adhesive layer 308, flock layer 312, and thermosetting adhesive layer 316. As can be seen from FIG. 3, the flock fibers in the flock layer 312 are substantially perpendicular to the planes of the carrier sheet 304 and adhesive layer 316 to provide a plush feel. To adhere the transfer 300 to a desired substrate, the thermosetting adhesive layer 316 is placed against the substrate 100 (FIG. 1) surface, and heat and pressure applied to the carrier sheet 304. The heat will soften and/or melt, at least partially, the thermosetting adhesive layer 316. When the heat is removed, the thermosetting adhesive layer 316 will adhere irreversibly to the substrate 100.

The carrier sheet 304 can be any desirable sacrificial carrier, such as cellulose (paper), microporous substrate (such as described in U.S. Pat. No. 6,025,068 and copending U.S. application Ser. Nos. 11/413,797, filed Apr. 28, 2006, 11/460,493, filed Jul. 27, 2006, 11/460,519, filed Jul. 27, 2006, 11/852,134, filed Sep. 7, 2007, and 11/533,699, filed Sep. 20, 2006, to Abrams and other known carriers.

The release adhesive 308 can be any suitable adhesive, such as those disclosed in any of the above copending U.S. applications.

The flock 312 used in any of the processes discussed herein can be any electrostatically chargeable fiber, such as fibers made from rayon, nylon, cotton, acrylic, and polyester. Preferably, the flock has a melting and/or softening point that is greater than and is resilient under the temperatures and pressures experienced in design manufacturing and later application processes to resist softening, deformation, and melting. Due to its low melt point, acrylic flock is undesirable in many applications. Resilient flock, such as rayon, nylon, and terephthalate (e.g., poly(cyclohexylene-dimethylene terephthalate) polymer flock, is particularly preferred.

The thermosetting adhesive 316 is commonly non-tacky and thermoplastic in nature as prepared. When the thermosetting adhesive 316 is heated to a temperature below its cure temperature it is typically thermally reversible, that it, it behaves like a thermoplastic adhesive, reversibly softening when heated and hardening when cooled. When heated below its cure temperature, the thermosetting adhesive 316 can be tacky. The cure temperature is the temperature required to effect a complete cure of the adhesive within a given time period. When heated to a temperature at or above its cure (or cross-linking) temperature, the heat causes the adhesive components to crosslink or to cure irreversibly. In other words, the adhesive is commonly non-tacky and thermoplastic in nature as prepared and, upon heating to a suitable temperature, above its cure temperature, fuses and becomes thermoset or substantially infusible and insoluble. The thermoset state is usually associated with the molecular constituents of the adhesive undergoing chemical reactions, induced by heat or radiation, to cross-link the molecular constituents into an infusible or insoluble state.

The thermosetting adhesive 316 can be any high polymer and can also include additives. For example, when the adhesive is a thermosetting adhesive, curing agents, such as organic peroxides, cyanates, and sulfur (in the case of rubber), may be incorporated in the adhesive 316 to cross-link (or harden) the adhesive or to facilitate or catalyze the cross-linking reaction. For example, linear polyethylene can be cross-linked or thermoset to a relatively insoluble and infusible state either by radiation or by chemical reaction. Examples of permanent adhesives include rubber, polyolefins, polyesters (e.g., poly(ethylene terephthalate)), polystyrenes, polyethylenes, acrylics, polyurethanes, poly(vinyl chlorides), nylons, phenolics, alkyds, polypropylene, amino resins, polyesters, fluorocarbons, epoxides, rubbers, silicones, and cellulosic and acrylic resins.

In one formulation, the thermosetting adhesive, when in the thermoplastic state, includes a compound containing three or more isocyanate groups per molecule (such as triphenylmethane triisocyanate, benzene triisocyanate, tolylene triisocyanate, silicon triisocyanate, ethylene tetraisocyanate, and diphenyl triisocyanate) in which a number of the isocyanate groups are blocked or masked with an isocyanate splitter-type material (such as a phenols and malonic ester), and a polyester containing three or four hydroxyl groups (such as glycerin, trimethylol propane, pentaerythritol, various polyesters with excess hydroxyl groups, and phenol formaldehyde resins) or a polyurethane. To convert the adhesive to the thermoset state, the adhesive is heated to a higher temperature, for example about 125 degrees Celsius or higher, for a short period of time to free the isocyanate groups from the masking or blocking material and permit their reaction with the hydroxyl groups of the polyester or polyurethane. To accelerate the decomposition reaction or the splitting off of the splitter-type material, a small amount of an accelerator such as a tertiary amine compound, tributyl amine, and tris-(dimethyl aminomethyl) phenol, may be added.

A preferred adhesive formulation is sold under the tradename SCHAETTI FIX™ by Schaetti AG. This is a thermoplastic polymer based on polyurethane. The polymer cross links, or thermosets, by heat activation at a temperature of at least about 130 degrees Celsius, with 150 degrees Celsius being preferred, and 160 degrees Celsius being even more preferred.

An important aspect of the invention is the formation of a liquid slurry of the adhesive (with the liquid being the continuous phase), which is then subsequently applied to the ends of the flock by a suitable technique such as screen-printing. Stated another way, the adhesive is in the form of a finely divided powder suspended in a carrier liquid, preferably where the carrier liquid is water. Or, stated in yet another way, the liquid slurry is substantially a heterogeneous mixture of the permanent adhesive in the carrier liquid. The adhesive particles are not substantially soluble in the carrier liquid (that is, most, if not all, of the permanent adhesive is not solubilized or dissolved by the carrier liquid) and exist as a distinct, discontinuous solid phase within the liquid carrier. Additives, such as surfactants (e.g., a surface-active agent, detergent, wetting agent, emulsifier, or compound that reduces the air-liquid and/or liquid-solid surface tension when dissolved in water or water solutions); thickeners (e.g., hydrophilic substances such as starches, gums casein, gelatin, phycocolloids, semi-synthetic cellulose derivatives, carboxymethyl-cellulose, polyvinyl alcohol, carboxy-vinylates, bentonite, silicates, and colloidal silica), anti-foaming or defoaming agents (e.g., a substance used to reduce foaming due to proteins, gases or nitrogenous materials, such as 2-octanol, sulfonated oils, organic phosphates, silicone fluids, and dimethylpolysiloxane), lubricants (low viscosity substances such as oils, fats, and waxes), and glycols can be added to the carrier liquid to suspend the solid adhesive particles in the carrier liquid.

The particle size of the adhesive is preferably small enough to permit the particles to be screen printed without clogging the screen-printing device. Such particle sizes are typically formed by cryogenic pulverizing techniques. In such techniques, the solid adhesive is frozen (or chilled to a low temperature) and, while in the frozen or chilled state, shattered with a mill, such as a hammer mill. The resulting particles are screened to provide the desired particle size fraction, with the oversize particles being rejected or recycled to the solid adhesive formation process. In one formulation, at least most of the particle sizes range from about 100 to about 500 microns. In another formulation, at least about 50% of the particles have a size of no more than about 65 microns, and even more commonly no more than about 60 microns.

The slurry is screen printed only in the desired image areas. With reference to FIG. 4, for example, the adhesive slurry is screen printed in areas 400, 404, 408, 412, 416, and 420 but not in area 424. As will be appreciated, the screen-printed slurry defines the areas, or letters. When the adhesive layer, when in the thermoplastic state or A-staged, is contacted with the substrate 100 and heated, the flock in areas 400, 404, 408, 412, 416, and 420 adhering to the adhesive layer 316 will bond, preferably in the thermoset state or B- and/or C-staged, to the substrate 100 while the flock in area 424 will not. In this manner, a clear, crisp or fine image can be produced without die cutting and weeding operations and subsequent removed material wastage.

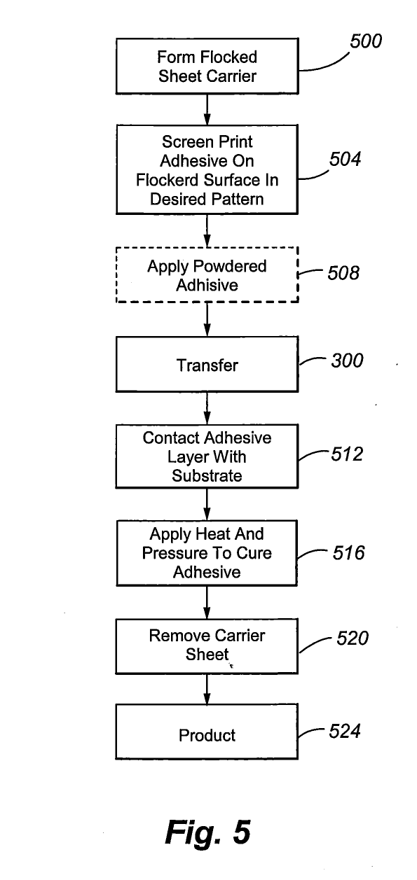

The thickness “T” of the adhesive layer (FIG. 3) can be important. A thin adhesive layer can inhibit the fibers from laying down during application of the transfer 300 to the substrate. As noted, heat and pressure are applied to the transfer 300 to cause the transfer 300 to adhere, in the thermoset state, to the substrate 100. In the absence of a thin adhesive layer, the adhesive layer 316 can not only flow into the area 424 and adversely impact the fineness of the image transferred onto the substrate 100 but also can “grab” fibers when deformed by the application of pressure, causing many of the fibers in the image to be transverse to the plane of the substrate. Such non-orthogonal fibers can mar the image and impact adversely the plushness of the flocked design. Preferably, the thickness of the adhesive layer 316 is no more than about 5 mil, more preferably ranges from about 1 to about 4 mils, and even more preferably ranges from about 2 to about 3.5 mils. The flock, in contrast, typically has a length of at least about 0.015 inch and even more typically a length of at least about 0.020 inch, with about 0.030 inch being more typical. A system and process for manufacturing the transfer 300 will now be discussed with reference to FIGS. 1-5.

In step 500, a flocked carrier sheet 200 (depicted in FIG. 2) is formed is formed by screen-printing the release adhesive film 308 in a desired pattern (which is typically the mirror image of the desired final flock pattern) on the carrier sheet 304 followed by electrostatically flocking the carrier sheet 304.

In step 504, the flocked carrier sheet 200 is contacted, preferably by screen-printing, with an adhesive slurry (which is a combination of the powdered thermosetting adhesive, water, and optional additives, with the thermosetting adhesive particles being capable of being cured). The adhesive slurry is screen printed in a desired image pattern. The screen-printed image pattern is typically the mirror image of the desired final flock pattern on the substrate 100.

While the screen-printed slurry is wet, additional dry, powdered thermosetting adhesive particles, in optional step 508, may be contacted with the screen printed slurry to increase the adhesive layer 316 thickness “T”. When the adhesive slurry has dried (or at least most of the carrier liquid has been removed, e.g., evaporated), the adhesive layer 316 is formed.

The product of step 504 and/or optional step 508 is the transfer 300.

In step 512, the adhesive layer 316 is contacted with the exterior surface of a desired substrate, such as a fabric or other textile, water bottle (e.g., a plastic water bottle) or other food or drink dispenser, and the like. Stated another way, the adhesive layer 316 is laid on the exterior surface.

In step 516, heat and pressure are applied to the transfer 300 to cause the adhesive layer 316 to thermally cure the thermosetting adhesive.

After heat and pressure have been applied for a sufficient time for the thermal curing reactions to substantially go to completion, the release or carrier sheet 304 is removed from the flock 312 in step 520 to form the product 524, such as depicted in FIG. 4. As noted, the flock not adhered to the adhesive layer 316 will be removed with the release sheet and adhesive 304 and 308, leaving the desired flocked image (which is shown as being “LEXTRA” in FIG. 4) on the substrate.

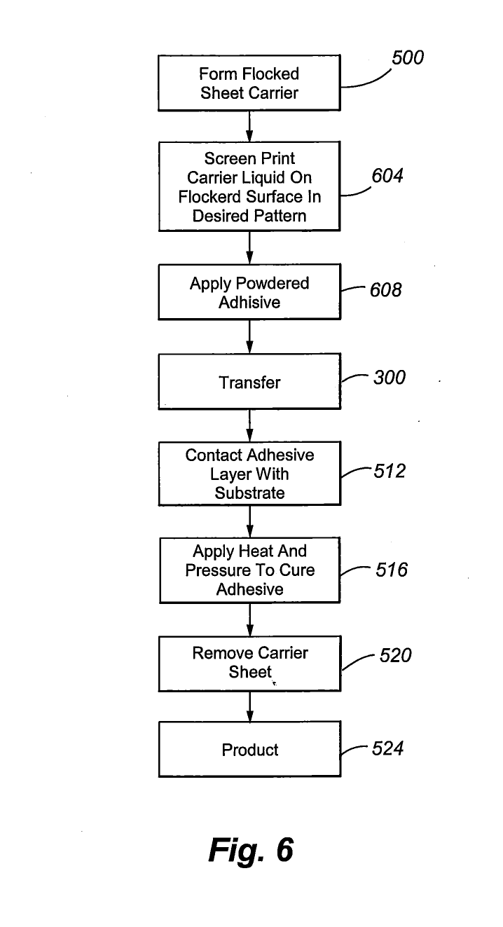

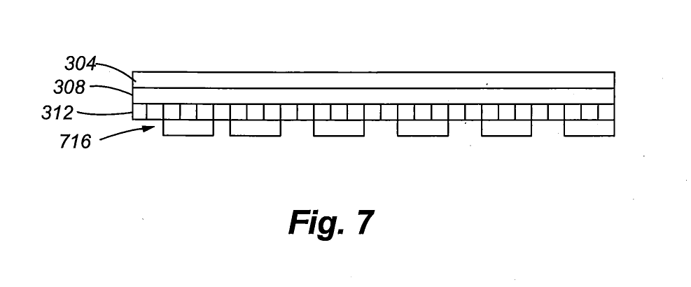

Another system and process for manufacturing the transfer 300 will now be discussed with reference to FIGS. 1-4, 6, and 7.

In step 500, a flocked carrier sheet 200 (depicted in FIG. 2) is formed as previously disclosed above.

In step 604, a liquid adhesive layer 716 is applied in a desired image pattern to the flock 312 of the flocked carrier sheet 200, preferably by screen-printing with the liquid adhesive. The screen-printed image pattern is typically the mirror image of the desired final flock pattern on the substrate 100. In this embodiment, the liquid adhesive can be any liquid adhesive. Preferably, the liquid adhesive is a liquid thermosetting adhesive. By way of example, the liquid adhesive is, without limitation, an acrylic, polyvinyl chloride, polyvinyl acetate, polyurethane, and polyester polyamide.

While the liquid adhesive layer is wet, a plurality of dry, powdered thermosetting adhesive particles are contacted, in step 608, with the liquid adhesive layer 716 to form an adhesive layer 316 having a thickness “T”. The adhesive layer is optionally dried; that is, at least most of the liquid adhesive solvent is removed. The liquid adhesive layer 316 solvent may volatilize at ambient temperature when the solvent is a volatile organic solvent.

The product of steps 604 and 608 is the transfer 300.

In step 512, the adhesive layer 316 is contacted with the exterior surface of a desired substrate, such as a fabric or other textile, water bottle (e.g., a plastic water bottle) or other food or drink dispenser, and the like. Stated another way, the adhesive layer 316 is laid on the exterior surface.

In step 516, heat and pressure are applied to the transfer 300 to cause the adhesive layer 316 to thermally cure the thermosetting adhesive. It can be appreciated that, when the liquid adhesive is a thermosetting adhesive, the thermosetting adhesives comprising the adhesive particles and liquid adhesive can react to form a single C-staged thermoset adhesive. It can be further appreciated, that the single C-staged thermoset adhesive can be one or more of a co-polymer, polymer alloy, homopolymer, or mixture thereof.

After heat and pressure have been applied for a sufficient time for the thermal curing reactions to substantially go to completion, the release or carrier sheet 304 is removed from the flock 312 in step 520 to form the product 524, such as depicted in FIG. 4. As noted, the flock not adhered to the adhesive layer 316 will be removed with the release sheet and adhesive 304 and 308, leaving the desired flocked image (which is shown as being “LEXTRA” in FIG. 4) on the substrate.

Yet another system and process for manufacturing the transfer 300 will now be discussed.

In step 500, a flocked carrier sheet 200 (depicted in FIG. 2) is formed as previously disclosed above.

In step 604, a carrier liquid layer 716 is applied in a desired image pattern to the flock 312 of the flocked carrier sheet 200, preferably by screen-printing with the carrier liquid. The screen-printed image pattern is typically the mirror image of the desired final flock pattern on the substrate 100. In this embodiment, the carrier liquid can be any volatile liquid, as for example, preferably having no adhesive properties after drying. By way of example, the carrier liquid is, without limitation, one or more of water alone, water containing optional additives, liquid alcohols, liquid polyurethane, or mixtures thereof. The additives can be, but are not limited to, surfactants, thickeners, anti-foaming agents, lubricants, alcohols or polyols, and glycols. The liquid alcohol can be any alcohol, blocked alcohol, polyol, blocked polyol, or mixture thereof, which can react with a polyurethane. The liquid polyurethane can be any screen-printable polyurethane.

While the carrier liquid is wet, a plurality of dry, powdered thermosetting adhesive particles are contacted, in step 608, with the carrier liquid layer 716 to form an adhesive layer 316 having a thickness “T”. The adhesive layer is optionally dried, that is, at least most of the carrier liquid is removed. The adhesive layer 316 may volatilize at ambient temperature when the carrier liquid is one or more of an alcohol, blocked alcohol, polyol, blocked polyol or mixture thereof.

The product of steps 604 and 608 is the transfer 300.

In step 512, the adhesive layer 316 is contacted with the exterior surface of a desired substrate, such as a fabric or other textile, water bottle (e.g., a plastic water bottle) or other food or drink dispenser, and the like. Stated another way, the adhesive layer 316 is laid on the exterior surface.

In step 516, heat and pressure are applied to the transfer 300 to cause the adhesive layer 316 to thermally cure the thermosetting adhesive.

After heat and pressure have been applied for a sufficient time for the thermal curing reactions to substantially go to completion, the release or carrier sheet 304 is removed from the flock 312 in step 520 to form the product 524, such as depicted in FIG. 4. As noted, the flock not adhered to the adhesive layer 316 will be removed with the release sheet and adhesive 304 and 308, leaving the desired flocked image (which is shown as being “LEXTRA” in FIG. 4) on the substrate.

A number of variations and modifications of the invention can be used. It would be possible to provide for some features of the invention without providing others.

For example in one alternative embodiment, decorative media other than flock can be used in the article in place of the flock layer 312. For example, glitter, glass beads, metal foil, and other decorative materials may be employed.

In yet another alternative embodiment, the adhesive layer 316 is screen printed on the substrate 100 and flock is then applied directly to the thermosetting adhesive layer 316 with or without an intermediate adhesive on the surface of the thermosetting adhesive layer 316 to hold the flock in position until the flock is pressed into the softened (that is, A- and/or B-staged) thermosetting adhesive layer 316 in a lamination station. In one configuration, the thermosetting adhesive layer 316 is heated to the point of being tacky (while still in the thermoplastic A- and/or B-stage state) and the flock fibers electrostatically flocked into the tacky adhesive layer. The adhesive layer may then be heated to a higher temperature to further soften and then cross-link the adhesive to the thermoset, cured state after the flock fibers have been pushed into the softened adhesive. In this embodiment, the intermediate assembly does not have the carrier sheet 304 and release adhesive 308 positioned on top of the flock layer 312.

The present invention, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, e.g., for improving performance, achieving ease and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover, though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method of manufacturing a flocked article, comprising:
providing a flocked surface having first and opposing second sides; and
applying an adhesive slurry comprising a carrier liquid and a plurality of thermosetting adhesive particles to the first side in a pattern, wherein the particles are capable of being softened by heat.

2. The method of claim 1, wherein the applied adhesive slurry pattern forms an adhesive layer and further comprising:
contacting the adhesive layer with a substrate; and
while the adhesive layer is in contact with the substrate, heating and applying pressure to the adhesive layer to substantially cure the thermosetting adhesive layer and adhere the adhesive layer permanently to the first side and the substrate.

3. The method of claim 1, wherein the second side is adhered to a release adhesive, the release adhesive being adhered to a carrier sheet, and wherein the adhesive slurry is applied discontinuously to the first side.

4. The method of claim 1, wherein at least some of the first side, after the applying step, is not in contact with the adhesive slurry.

5. The method of claim 1, wherein the applied adhesive slurry pattern has a thickness of no more than about 5 mils.

6. The method of claim 2, wherein the adhesive layer has a thickness of no more than about 5 mils.

7. The method of claim 1, further comprising after the applying step, applying a further plurality of adhesive particles to the desired printed adhesive slurry pattern, wherein the further adhesive particles are in the form of a dry powder.

8. The method of claim 7, wherein at least one of the following is true:
i) wherein at least most of further adhesive particles have a size ranging from about 100 to 500 microns;
ii) wherein at least about 50% of the further adhesive particles have a size of no more than about 60 microns; and
iii) wherein the further adhesive particle comprise a polyurethane and blocked polyisocyanate, and wherein the polyisocyanate having three or more isocyanate groups per molecule.

9. The method of claim 1, wherein at least most of the thermosetting adhesive particles have a size ranging from about 100 to about 500 microns.

10. The method of claim 1, wherein at least about 50% of the thermosetting adhesive particles have a size of no more than about 60 microns.

11. The method of claim 1, wherein the carrier liquid is water.

12. The method of claim 1, wherein the thermosetting adhesive is a polyurethane.

13. The method of claim 1, wherein the thermosetting adhesive particles comprise a polyurethane and blocked polyisocyanate and wherein the polyisocyanate having three or more isocyanate groups per molecule.

14. The method of claim 1, wherein the thermosetting adhesive has a cure temperature ranging from about 130 to about 160 degrees Celsius.

15. The method of claim 1, wherein the thermosetting adhesive has a melt temperature ranging from about 50 to about 160 degrees Celsius.

16. The method of claim 15, wherein the thermosetting adhesive has a melt temperature ranging from about 100 to about 140 degrees Celsius.

17. The flocked article manufactured by the steps of claim 1.

18. A flocked article, comprising:
a flock layer having a first and opposing second surfaces; and
a thermosetting adhesive layer in contact with the first surface, wherein the thermosetting adhesive layer is a slurry comprising a plurality of thermosetting adhesive particles and carrier liquid.

19. The article of claim 18, wherein the thermosetting layer has a thickness of no more than about 5 mils.

20. The article of claim 18, wherein the second surface is adhered to a release adhesive, the release adhesive being adhered to a carrier sheet and first surface is adhered to the thermosetting adhesive layer and, wherein the thermosetting adhesive layer is in direct contact with the first surface.

21. The article of claim 18, wherein the thermosetting adhesive layer is a polyurethane.

22. The article of claim 18, wherein the thermosetting adhesive layer is discontinuous and wherein at least some of the first surface of the flock layer is not in contact with the adhesive layer.

23. The article of claim 18, wherein the carrier liquid is water.

24. A process for manufacturing a flocked decorative article, comprising:
providing a flocked surface having first and opposing second sides; and
applying at least one of a carrier liquid and liquid adhesive onto the first side in a pattern; and
forming an adhesive layer by contacting a plurality of thermosetting adhesive particles with the liquid adhesive, wherein the thermosetting adhesive particles are in the form of a dry powder.

25. The process of claim 24, further comprising:
contacting the formed adhesive layer with a substrate; and
while the adhesive layer is in contact with the substrate, heating and applying pressure to the adhesive layer to substantially cure the adhesive layer and adhere the adhesive layer permanently to the first side and the substrate.

26. The process of claim 24, wherein the second side is adhered to a release adhesive, the release adhesive being adhered to a carrier sheet, and wherein the at least one of carrier liquid and liquid adhesive is applied discontinuously to the first side.

27. The method of claim 24, wherein at least one of the following is true:
i) at least most of the thermosetting adhesive particles have a size ranging from about 100 to 500 microns;
ii) at least about 50% of the thermosetting adhesive particles have a size of no more than about 60 microns;
iii) the thermosetting adhesive particles comprise a polyurethane and blocked polyisocyanate, and wherein the polyisocyanate having three or more isocyanate groups per molecule;
iv) the thermosetting adhesive particles have a cure temperature ranging from about 130 to about 160 degrees Celsius; and
v) the thermosetting adhesive particles have a melt temperature ranging from about 50 to about 160 degrees Celsius.

28. The method of claim 24, wherein after the applying step at least some of the first side is not in contact with the at least one of the carrier liquid and liquid adhesive, and wherein the at least one of the applied carrier liquid and liquid adhesive has a thickness of no more than about 5 mils.

29. The method of claim 24, wherein one of the following is true for the at least one of the carrier liquid and liquid adhesive:
(i) the carrier liquid is water alone;
(ii) the carrier liquid is an aqueous solution;
(ii) the carrier liquid is a solvent for the thermosetting adhesive particles;
(iii) the carrier liquid is selected from the group consisting essentially of liquid alcohols, liquid polyurethane, liquid blocked polyols, and mixtures thereof;
(iv) the liquid adhesive is one of a liquid thermosetting adhesive and thermoplastic adhesive;
(v) the liquid adhesive is a liquid thermosetting adhesive, wherein the liquid thermosetting adhesive is cross-linkable with the thermosetting adhesive particles.

30. A flocked decorative article, comprising:
a plurality of flock fibers having first and opposing second ends, wherein the first ends are adhered to a release adhesive, the release adhesive being adhered to a carrier sheet;
a thermosetting adhesive layer in contact with the second ends, wherein the thermosetting adhesive comprises a plurality of thermosetting adhesive particles, wherein the thermosetting adhesive comprises a polyurethane and blocked polyioscyante and wherein the polyioscynate having three or more isocyanate groups per molecule; and
a carrier liquid layer in contact with the second ends and the plurality of thermosetting adhesive particles, wherein the thermosetting adhesive and carrier liquid layers are at least mostly intermixed, wherein the intermixed thermosetting adhesive and carrier liquid layer has a thickness of about 5 mils.
